(19) United States
(12) Patent Application Publication
(10) Pub. No.: US 2017/0284301 A1
(43) Pub. Date: Oct. 5, 2017

(54) TURBOCHARGED ENGINE FED BY MAGNETIZED FLUIDS AND ASSOCIATED METHOD

(71) Applicant: TITANO S.R.L., Napoli (NA) (IT)

(72) Inventors: Alessandro BOVE, Napoli (NA) (IT); Fabrizio BOVE, Napoli (NA) (IT)

(73) Assignee: TITANO S.R.L., Napoli (IT)

(21) Appl. No.: 15/508,192

(22) PCT Filed: Aug. 31, 2015
(86) PCT No.: PCT/IB2015/056599

§ 371 Date: Mar. 2, 2017

(30) Foreign Application Priority Data
Sep. 2, 2014 (IT) RM2014A000495

(51) Int. Cl. F02C 7/22; F02C 7/057; F02C 3/20

(52) U.S. Cl. CPC F02C 7/222; F02C 3/20; F02C 7/057; F05D 2220/32; F05D 2260/607

(57) ABSTRACT

Disclosed is a combustion engine, that includes a first, fixed stator portion (100) and a second, mobile rotor portion (110), and wherein at least the first, fixed stator portion (110) identifies an air intake pipe (140) and wherein the second, mobile rotor portion (110) is positioned inside the first, fixed stator portion (100); the first and the second portion (100, 110) include magnetic element (200) which are configured to magnetize the air admitted in the intake pipe (140) with a first polarization; the combustion engine further including at least one fuel intake pipe, which in turn is physically associated with magnetic element which are configured to magnetize the fuel with a second polarization which is different from the first polarization.

### TECHNICAL FIELD

The present invention describes an innovative integrated system for the magnetization of fuel and of the entire engine itself, which is characterized in the presence of a plurality of components which are constituted by a plurality of individual elements which are conveniently arranged both in the tank, and around any combustion engine, in order to improve the yield thereof, decrease fuel consumption and reduce the polluting impact thereof.

In detail, the present invention relates to a turbine engine which is fed by magnetized fluids.

### BACKGROUND ART

For some time and particularly since the early 1960s, it has been known that magnetism exerts a positive influence on the efficiency of combustion engines.

The influence of magnetism on combustion has also been acknowledged very often in recent research carried out in academia, and has been separated into two different types of use: patents for magnetic devices installed on feed pipes for combustion engines and patents for magnetic immersion devices in the fuel tank. This has been a very positive influence, as noted in U.S. Pat. Nos. 4,572,145 of 1986, U.S. Pat. No. 5,048,489 of 1991, and U.S. Pat. No. 5,124,045 of 1992, and in German patent no. DE 44171676 and in the WO 00/06888 patent of 2000. Up to now however all patents and intellectual property rights that have been filed have related exclusively to devices adapted to use magnetic fields to irradiate only the fuel fed, independently of what that is, and the air.

The aim of the present invention is thus to describe a turbine engine that is free from the drawbacks described above.

Another aim of the present invention is to describe a method for fueling a turbine engine which solves the drawbacks described above.

### SUMMARY OF THE INVENTION

According to the present invention, what is provided is an combustion engine, characterized in that it comprises a first, fixed stator portion and a second, mobile rotor portion, and wherein at least said first, fixed stator portion identifies an air intake pipe and wherein said second, mobile rotor portion is positioned inside the first, fixed stator portion; said first and said second portion comprise magnetic means which are configured to magnetize the air admitted in said intake pipe with a first polarization; said combustion engine further comprising at least one fuel intake pipe, which in turn is physically associated with magnetic means which are configured to magnetize said fuel with a second polarization which is different from said first polarization.

Advantageously, said first, fixed stator portion comprises at least one portion which is made of metal.

Advantageously, said second, mobile rotor portion comprises at least one portion which is made of metal.

Advantageously, said metal is a ferromagnetic, paramagnetic or diamagnetic material.

Advantageously, said magnetic means are radially arranged around said first, fixed stator portion and/or said second, mobile rotor portion.

Advantageously, said engine comprises an air compressor stage and said magnetic means are installed upstream of said air compressor stage.

Advantageously, said magnetic means are furthermore also installed downstream of said air compressor stage.

Advantageously, the engine comprises a tank having at least one immersion container, which is provided with a plurality of holes and is placed proximate to the fuel pipe and contains at least one cylindrical container, which is provided with a plurality of holes and is adapted to contain in turn a plurality of magnetic elements which are mutually separated by a corresponding number of non-magnetic spacers.

Advantageously, said magnetic means comprise magnets that are made with ferromagnetic and/or paramagnetic elements, rare earth elements and, in particular, neodymium and samarium-cobalt rare earth elements.

Advantageously, said non-magnetic spacers are ceramic spacers.

According to the present invention, what is also described is a method of feeding a turbine engine, characterized in that it comprises:
a first step of association of magnetic means provided with a same first polarity with a first, fixed external portion of said turbine engine and with a second, mobile rotating internal portion of said turbine engine;
a step of feeding said turbine engine with a fuel flow passing inside a feed pipe that comprises magnetic means which are provided with a second polarity, different from said first polarity;
a step of feeding air into a combustion chamber which is internal to said turbine engine and is provided at least partially inside said first external portion, and of a subsequent mixing of said air with said fuel;

and wherein said step of feeding said air into said combustion chamber is characterized in that it comprises a magnetization of the air molecules according to a first polarity which is different from said second polarity assumed by the molecules of said fuel.

Advantageously, said method comprises an installation of magnetic means inside a body of a fuel filter of said engine, said magnetic means being configured to allow the further magnetization of said fuel.

Advantageously, said magnetic means are positioned at a preset distance with respect to said combustion chamber, and said distance is calculated according to at least one maximum torque speed of said turbine engine.

Advantageously, said fuel passes through a fuel filter which is in turn magnetized thanks to at least one pair of magnetic means which are directly placed on said fuel filter and are adapted to create a polarization with a sign which is the same as the one provided by the magnetic means which are positioned at at least one fuel intake pipe of said combustion engine.

### DESCRIPTION OF THE FIGURES

The invention will be described in a preferred, but non-limiting embodiment thereof with reference to the accompanying drawings wherein:

FIG. 1 shows an immersion container 1 arranged inside the fuel tank 2. Note hat the immersion container 1 is arranged proximate to the fuel exit pipe 8 so as to magnetize it fully before it enters the pipe 8.

FIG. 2 shows the immersion container 1 inside which, in addition to the fuel that flows through the holes 40, there is a plurality of perforated solid cylindrical containers 3 containing inside them the magnetic paramagnetic elements 5 which are constituted by rare earth elements such as samarium-cobalt and neodymium. Said solid containers 3 are provided with a plurality of holes 41 and are stably anchored to the bottom of the immersion container 1, which is arranged in the fuel tank 2, by way of at least one anchoring bracket 4. The immersion container 1 is anchored with a bracket or a plurality of brackets 4 inside the tank 2 and is positioned so as to be as close as possible to the fuel exit pipe 8. The magnetic elements 3 are provided in the form of stacked disks 5, and are constituted by rare earth elements such as neodymium and samarium-cobalt. Between the individual magnetic disks 3, there are suitable ceramic spacers 6 which are adapted to space apart, stabilize and increase the magnetic field produced by the magnetic disks 5.

FIG. 3 shows the passage container 9 in which the fuel pipe 8 originating from the tank 2 enters a containing structure 9 inside which the pipe 8 follows a series of folds and/or curves 12, thus creating a coil and/or windings so that a plurality of magnets 10 can be stably positioned proximate to said coil and/or shape structure of pipes so as to electrically and magnetically charge the fuel that flows inside the pipe 8, along the entire route.

FIG. 4 shows a pair of concave magnets 14 made of ferrite or of samarium-cobalt, which are arranged about a substantially rectilinear portion of the pipe 8. The magnets are adapted to further magnetize the flow of fuel which flows inside the pipe 8. Said pairs of magnets 14 are arranged between the fuel filter and the ale pump of the engine and in any case before the point of injection of the fuel into the combustion chamber of the engine. Externally they have washers 15 made of rare earth elements such as neodymium or samarium-cobalt. The whole is covered externally with a plate of screening material at least 1 mm thick.

FIG. 5 shows a sectional view of the pair of concave magnets 14 in which it can be seen that charges of the same sign are in the same positions, internal 21 or external 11, of each pair of magnets 14.

FIG. 6 shows a plurality of concave magnets made of ferrite or neodymium or samarium-cobalt 16, optionally covered with a pair of neodymium washers 15, which are arranged radially about the air intake pipe 17 which feeds the combustion engine in the present invention. Said magnets 16 are kept stably in contact with the external surface of the air intake pipe 17, by way of at least one retaining band 18, and are covered on the outer face by any kind of insulating layer, at least 1 mm thick, in order to screen the magnetic field.

FIG. 7 shows the magnets 16 directly installed on the cooling pipe 20 of the combustion engine. The number of magnets 16 present on the cooling pipe 20 is, in the example shown, equal to ten.

FIG. 8 shows the magnets 10 complete with neodymium washers installed around the fuel filter 31. Note also the retaining band 18 and the fuel pipe 8.

FIG. 9 shows a sectional side view of a turbine engine in the present invention; in particular such Figure shows an engine of the turboprop type.

FIG. 10 shows a front elevation view of a cross-section of a turbine engine of the jet type, with magnetic means 200 according to the present invention present, which are installed both at the rotor and at the housing of the engine itself at an air intake pipe.

### DETAILED DESCRIPTION OF THE INVENTION

In the present description, the term magnet means any permanent magnet that is capable of creating a persistent magnetic field of from 0.4 teslas to 1.49 teslas, or a permanent magnet that is capable of creating a magnetic field constituted by the sum of many persistent magnetic fields, and of intensity considerably exceeding 1.49 teslas. Therefore, in the present description, the term magnet means all so-called “hard permanent magnets” with high coercivity. The permanent magnets used in the present invention are constituted by ferromagnetic and/or paramagnetic materials. The permanent magnets used in the present invention are made of natural magnetic minerals like magnetite, cobalt, nickel, and rare earth elements like gadolinium or dysprosium. In addition to the above mentioned natural magnets, synthetic materials can be used like boron, ceramic composite magnets, AlNiCo magnets, TiCoAl magnets, injection-molded magnets and flexible magnets. The preferred magnets in the present invention are those constituted by rare earth elements, i.e. those belonging to the group of lanthanides to which samarium-cobalt and neodymium-iron-boron magnets belong.

The power of the magnets and of the paramagnetic substances varies between 0.4 teslas and 1.49 teslas.

In order to enable an exhaustive understanding of the method of treatment of the present invention, the devices in the present patent application will now be described in detail, and are the following:

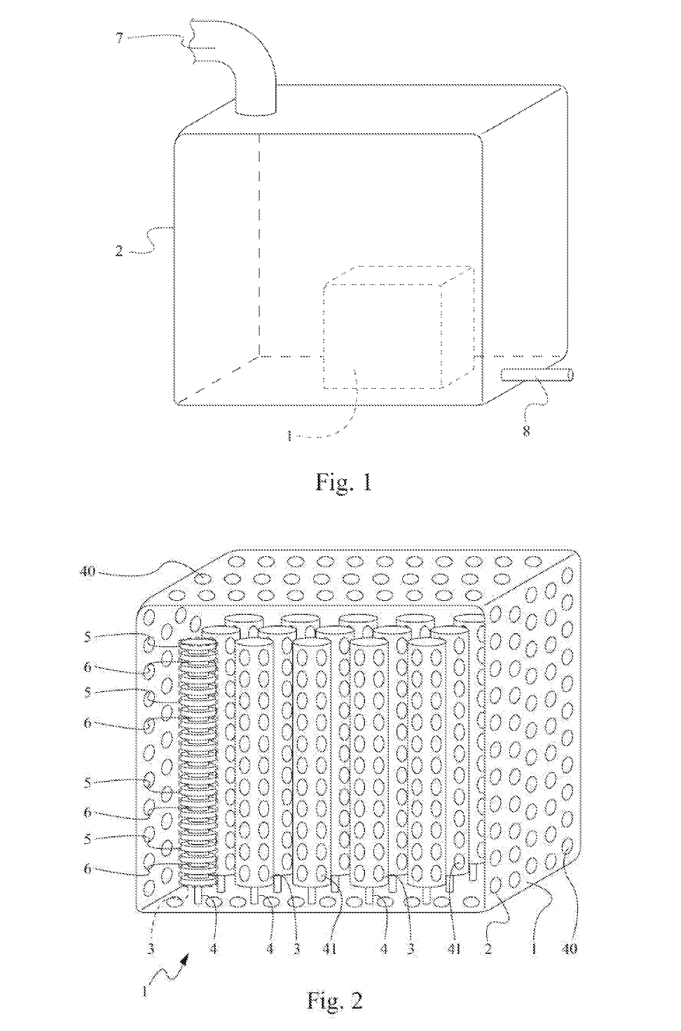

1) The first device, referred to as an immersion container 1, is constituted by at least one conventional container which is conveniently perforated by way of a plurality of openings 40, which are adapted a facilitate the direct contact of the fuel with the magnetic elements 5 arranged inside said immersion container 1. Said immersion container 1, which is shown in FIGS. 1 and 2, must be stably positioned inside the fuel tank 2 of the combustion engine to lie treated. There can be one immersion container or there can be more than one. This depends on the power of the engine to be treated, on the capacity of the tank and on the available space. In order to prevent wear and vibrations, the immersion container 1 must be fixed to the internal structure of the tank 2 with adapted welded or screwed brackets or by way of any other retaining element that renders it stably coupled to the inside of the tank 2, taking into account the use of the engine, the size of the tank 2 and its application on stationary land engines, aircraft engines, ship or watercraft engines or engines in any means of terrestrial locomotion, independently of whether it moves on rails, tires, or link tracks. The immersion container 1 must preferably be arranged proximate to the fuel exit pipe 8. Inside said immersion container or containers 1 arranged in the fuel tank 2 according to the technique described in the present invention, is at least one solid container of any shape, preferably cylindrical 3, preferably a plurality of cylindrical solid containers 3, which contain inside them a plurality of magnetic elements 5 constituted by disk-shaped permanent magnets constituted by some rare earth elements, some of which are samarium-cobalt and neodymium. Interposed between said magnetic elements 5 are ceramic spacers 6, which are also disk-like and are conveniently spaced apart in order to increase their magnetic effect. Said solid containers, preferably cylindrical 3, are in turn stably anchored to the bottom of the immersion container 1 and in order to facilitate their contact with the fuel to be magnetized, they have a plurality of holes 41. The anchoring occurs by way of stable locking systems 4 such as screws or brackets, so as to conveniently space said solid containers, preferably cylindrical 3 apart from each other by at least three centimeters, so as to optimize the magnetic field created. Each cylindrical solid container 3, arranged inside the immersion container 1 which in turn is immersed inside the tank 2 in a position inside the tank as close as possible to the exit point of the pipe to feed the engine in order to treat the maximum amount of fuel, is made so as to favor as far as possible contact between the fuel contained in the tank 2 and said magnetic elements 5. This contact is essential in order to favor as far as possible the resistance and consequently the time of contact between the fuel and the magnetic components 5, so as to favor the molecular treatment and the magnetization of the fuel. Said magnetic elements 5 are provided in the form of cylindrical disks constituted by rare earth elements such as neodymium and samarium-cobalt, but they can also have other forms and shapes. Between the individual magnetic disks 5 are ceramic spacers 6 which are adapted to space apart and optimize the individual magnetic fields produced by the magnetic disks 5, thus increasing and optimizing the overall power of the resulting magnetic field. The structure of all the above mentioned containers, the immersion container 1 and the cylindrical containers 3 can be made of any solid material, of metal, of any metal alloy or of any natural or synthetic polymer which is not soluble in the fuel contained in the tank 2. Both the cylindrical container 3 and the immersion container 1 according to the present invention can have any form and shape, are provided in a solid structure provided with a plurality of holes 41 and 40 respectively and made of any rigid material, of metal, of any metal alloy or of any natural or synthetic polymer which is not soluble in the fuel present in the tank 2.

The arrangement and the shape of said cylindrical containers 3 inside the immersion container 1 obviously can vary as a function of the size of the tank 2 but it must be noted that at least one immersion container 1, with at least 10 cylindrical containers 3 inside it, is needed for each 2000 liters of fuel contained. The indicative height of each cylindrical container 3 and, consequently, of the immersion element 1 vary, as a function of the supply flow rate and of the type of engine being subjected to the magnetization and molecular treatment process according to the present invention, and range from a minimum height of 6 centimeters, ideal for the tanks of motorcycles, to well over 100 centimeters in height for magnetizing the tanks on board ships, and preferably the height of each cylindrical container is from 20 to 40 centimeters, and the optimal height is around 30 centimeters. The density of the magnetic flux originated by the container, when fitted with the magnetic disks 5 made of rare earth elements and with the ceramic spacers 6, is of the order of over 1.17 teslas. The magnetic disks 5 are made of any rare earth element, preferably neodymium with a magnetic power of at least 1.17 teslas. The immersion container or containers 1 must be arranged inside the fuel tank 2 and proximate to the fuel exit pipe 8.

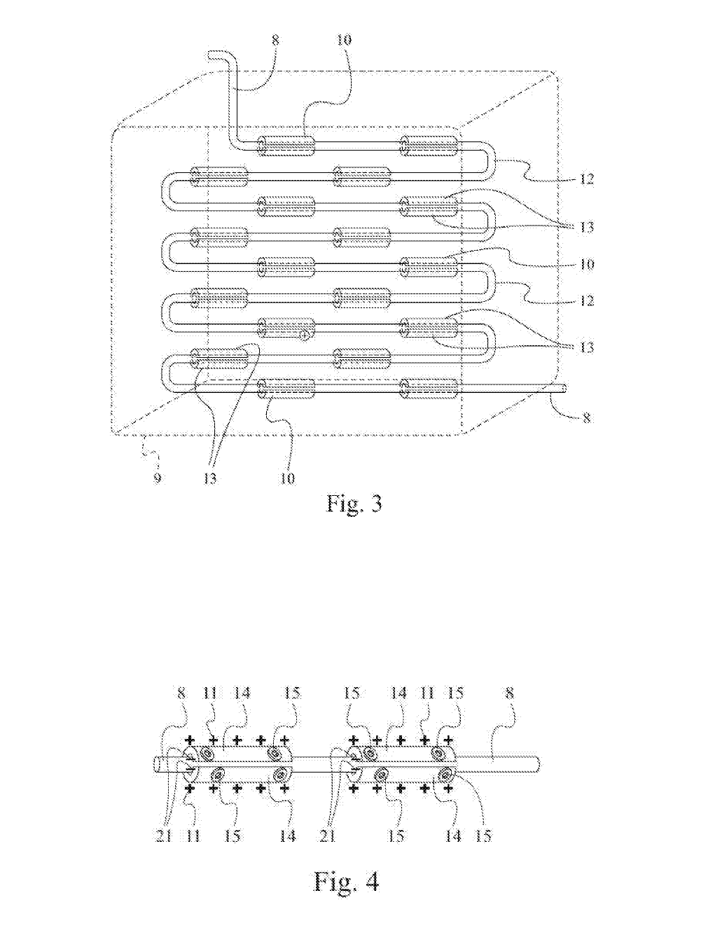

2) The second device in the present invention is the passage element 9. Said passage element 9, as shown in FIG. 3, is a parallelepiped-shaped solid structure into which the fuel pipe 8, originating from the tank 2 of the combustion engine, enters, following a series of folds and/or curves 12 so as to create a coil and/or a winding of pipes so that a plurality of magnets 10 can be conveniently and stably positioned. The manifold and/or the winding of pipes 12 makes it possible to electrically charge the fuel that flows inside said pipe 8 for a long section. The fuel that flows inside the pipe 8, by passing proximate to the magnets 10 present on the coil and/or the winding of pipes 12, is charged by said magnets 10 which are constituted by ferrite together with rare earth elements like neodymium and samarium-cobalt. The fuel that was previously electrically charged is thus further magnetically treated with charges of the same sign, for the entire route. The sign of the charge given to the fuel must be the same as the sign of the charge that will be received by the elements of the third device and of the subsequent devices prior to being put in contact with the air which instead will be provided with a charge of the opposite sign. Said charge is conferred on the fuel by the magnetic elements 10 and, independently of whether it is positive or negative, it must also be the same sign as the sign of the charge present in the device for treating the cooling liquid. Furthermore, said charge must necessarily have the opposite sign to that created in the air feed device, which is described below. When it reaches the end of the passage container 9, the fuel will necessarily have passed through ten pairs 13 of mutually opposite magnets. Said mutually opposite magnets 13 have a slightly convex shape in order to increase the effectiveness of the magnetic action and in order to best follow the shape of the pipe 8 that they have to envelop. The number of said magnets 10 is from 8 to 30 for each passage container 9.

3) The third device, for the magnetization of fuel in order to optimize the performance of any combustion engine, according to the present invention, as shown in FIG. 4, is characterized by the presence of at least one pair, preferably up to six pairs, of convex magnets made of ferrite, neodymium or samarium-cobalt 14, which are arranged about a substantially rectilinear and/or curved portion of the fuel pipe 8. Said pairs of magnets 14 arc, also adapted to further increase the magnetization of the stream of fuel that flows inside the pipe 8. Said pairs of magnets 14 are arranged shortly before or proximate to the a/c mechanical fuel supply pump and/or proximate to the point of injection of the fuel itself into the combustion chamber of the engine. Said pairs of magnets 14 are convex and made of ferrite, neodymium or samarium-cobalt and are approximately 10 centimeters long by 3 centimeters wide and 2.5 centimeters thick, and they must be calibrated for operating temperatures of at least 110 degrees centigrade. Their number varies from 2 to 12, and preferably 5 pairs of magnets are installed. Furthermore, said pairs of magnets 14 can be covered by a plurality of neodymium washers 15, which are adapted to further increase the magnetic field created. The charge induced, independently of whether it is positive or negative, must compulsorily have the same sign as that induced in the engine cooling system and as that induced in the previous devices for supplying and treating the fuel, but it must have the opposite sign to that induced in the air feed device.

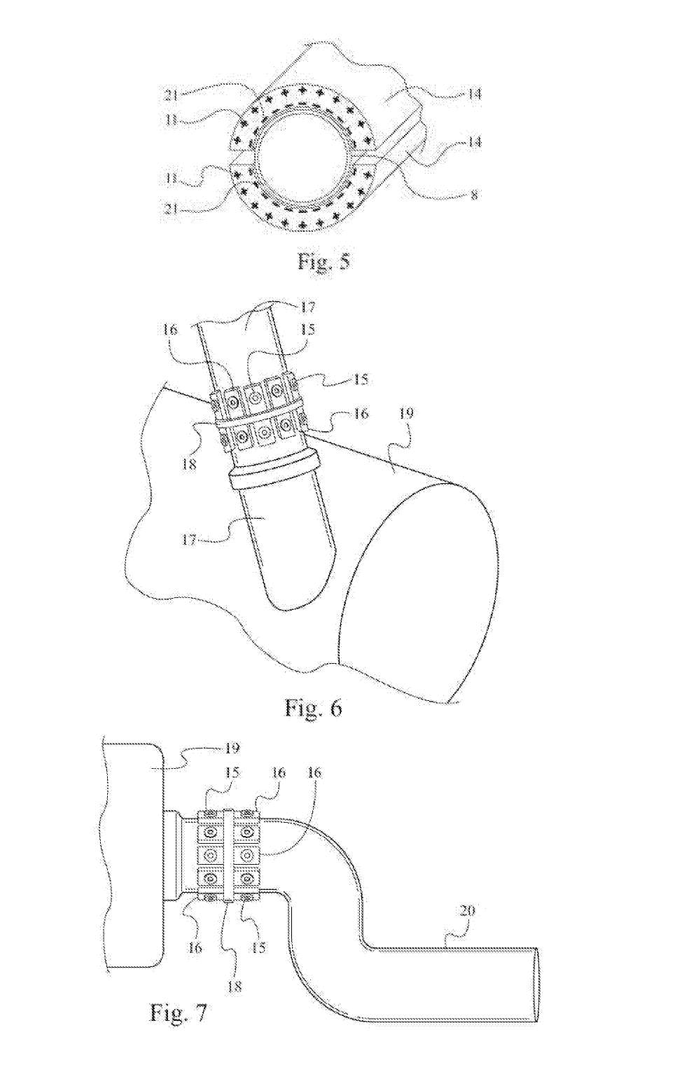

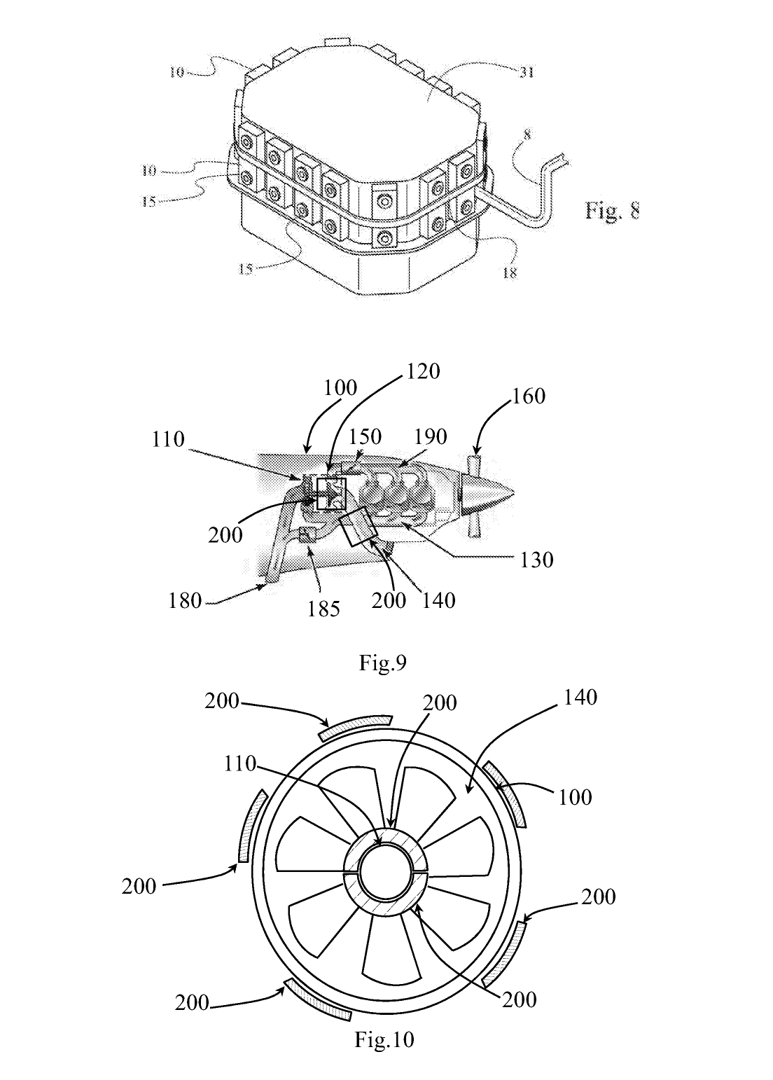

4) The fourth device, shown in FIG. 6, of the method of treatment of the fuel-air mixture supplied to an combustion engine, is constituted by a plurality of concave magnets made of ferrite 16, which are optionally covered with a pair of neodymium washers 15, and are arranged radially about the air intake pipe 17 that supplies any combustion engine. Said magnets 16 are kept stably in contact with the external surface of the air intake pipe 17, by way of at least one retaining band 18. The magnetic field created by said magnets made of neodymium-ferrite or of samarium-cobalt 16 will have the opposite sign, independently of whether this is positive or negative, to the sign with which the fuel passing through the devices 2 and 3 has been charged. This expedient thus makes it possible to give opposite charges to the fuel and to the air fed to the combustion engine. It is this difference in charge between the two components of the combustion mixture, the air and the fuel, which optimizes the step of combustion and the yield of said integrated magnetization system while also obtaining the molecular breakdown and reduction of viscosity of the fuel itself. As can be seen from the present discussion, the system in the present invention must necessarily be viewed as a single, integrated system that tends to magnetize, thanks to its intense magnetic field and the plurality of circuits, the entire engine, even though it is provided with six different devices which, however,all contribute to achieving the same goal. The number of magnets 16 present on the air supply pipe 17 is indicatively between 4 and 40, and preferably 20. The size of said magnets 16 is indicatively equal to 10 centimeters long, 3 centimeters wide and 2.5 centimeters thick. The shape of the magnets 16 is vaguely concave in order to better adhere to the air intake pipe 17 on which they are installed. The composition of said magnets can be neodymium-ferrite or samarium-cobalt. Said magnets 17 have a minimum magnetic field density of approximately 1.17 teslas. For the manufacture of the supply pipe 17, obviously preference must be given to all materials that can transmit the magnetic field created by the magnets 16 inside said pipe 17. The temperature that said magnets 17 must withstand must be at least 110 degrees, at which temperature they must not lose their magnetization power. The position of said magnets must be as close as possible to the combustion chamber of said combustion engine, taking into account the temperature of the positioning location and the ability of the magnets to withstand such temperature without losing the magnetic characteristics.

5) The fifth magnetic device, shown in FIG. 7, is similar to the fourth device, except in this case the magnets 16 are directly installed on the cooling pipe 20 connected to the radiator of the combustion engine and they magnetize the water and/or the liquid of the cooling system with the same sign with which the fuel is charged, effectively making the entire engine magnetically charged with the same sign which is opposite to the sign of the air supply. The sign of polarization of the water is therefore opposite to that of the air supplied to the engine. The number of magnets 16 present on the cooling pipe 20 is indicatively between 4 and 40, and preferably 20. The size of said magnets 16 is indicatively equal to 10 centimeters long, 3 centimeters wide and 2.5 centimeters thick. The shape of the magnets 16 is vaguely concave in order to better adhere to the cooling pipe 20 on which they are installed. Said magnets 16 have a minimum magnetic field density of approximately 1.17 teslas. The number of magnets 16 present on the cooling pipe 20 is indicatively between 4 and 40, and preferably 20. Said magnets 16 must be made by taking account of the temperature they have, to withstand, which is at least 110 degrees. This is the temperature at which they must function without losing their magnetization power.

6) The sixth device is entirely similar in all respects to the fourth device, except that in this case the magnets 16 are directly installed around the fuel filter 31 connected to the combustion engine. Also in this case, the sign induced in the fuel fed to the engine, independently of whether it is positive or negative, must be the same as the sign induced in the previous systems for treating the fuel and the opposite to the sign given to the air fed to the engine. The number of magnets 16 present on the fuel filter is indicatively between 5 and 14, and preferably 10 for an MTU 396 Diesel engine. The size of said magnets 16 is indicatively equal to 10 centimeters long, 3 centimeters wide and 2.5 centimeters thick. The shape of the magnets 16 is vaguely concave in order to better adhere to the fuel filter 31 on which they are installed. Said magnets 16 have a minimum magnetic field density of approximately 1.17 teslas. The number of magnets 16 present on the fuel filter 31 varies as a function of the power of the engine and is indicatively from 5 to 20, and preferably 10. Account must be taken of the temperature that the magnets must withstand, which must be at least 110 degrees or higher, without losing their magnetization power.

All the magnets placed on the fuel and air pipes can be screened with a protectiveayer of at least 1 millimeter in order to reduce dispersion and increase the efficiency of the system and better clamp the magnets to the fuel, cooling, and air pipes.

Alternatively, it is also possible to magnetize the fuel before it is introduced inside the tank 2, so as to improve its quality and fluidity while simultaneously decreasing its density. The process of magnetization in the present invention tends, in addition to improving the quality of the fuel by reducing the asphaltenes and carbon residues dissolved in it, to charge the fuel and the air fed to the engine with opposite signs and also to break down, at the molecular level, the carbon chains and the molecular aggregates which are present in the fuel itself. Obviously the method described in the present industrial patent application tends to be more effective the more the fuel has been treated. The results obtained show that by adopting the technique described above, it is possible to obtain a substantial saving in fuel consumption, up to even halving the costs thereof. Furthermore, by decreasing the viscosity of the fuel and improving its quality, an overall improvement is obtained in the yield of the engine, by decreasing the fuel consumption, increasing the engine torque, and also reducing its exhaust, harmful emissions and the carbon deposits in the combustion chamber. In the combustion chamber of the engine treated according to the technique described in the present invention, the encounter between the molecularly and qualitatively treated fuel charged with a sign, and the air charged with the opposite sign, favors the creation of an ideal fuel-air mixture. An optimal mixing naturally provides an optimal combustion, appreciably improving the overall yield of the combustion engine on which said apparatus is installed. The apparatus in the present invention is installable on any combustion engine, independently of whether it runs on Diesel fuel, gasoline, LPG, methane, kerosene, oil, alcohol or any other liquid or gaseous fuel.

For an engine, at least 220 hours of operation with the system fitted are required in order to see the benefits of the system and begin to evaluate its efficiency, and its optimal performance is reached after another 200 hours of operation. This applies to combustion engines of the Otto cycle type, and also to turbine engines like that described in the present description.

In fact, in the first hours the engine is magnetized and the combustion chambers are cleaned, while the subsequent hours stabilize and optimize the yield. The method of magnetization in the present invention causes no damage to the combustion engines on which it is installed, and actually increase their operating lifetime over time.

Optionally, furthermore, it is also possible to install magnets on the oil feed circuits, so as to favor further reduction of engine consumption.

In detail, the engine in the present invention, in addition to comprising the parts described above, is an engine of the rotary type, which is susceptible of being installed on board aircraft or helicopters.

The engine in the present invention comprises a first, fixed external portion 100 (a stator), the function of which is to support a second, internal portion which rotates 110 (a rotor), which supports one or more fans 120 for supplying air coming from an intake pipe 140 in an internal combustion chamber 130 thereof, where the air is mixed together with a fuel (typically but not exclusively aviation kerosene) in order to be burned.

In detail, both the first, fixed portion and the second, mobile rotating portion have at least one portion made of metal susceptible of being magnetized. Preferably such material thus has paramagnetic, ferromagnetic, or diamagnetic characteristics.

In detail, the engine shown in FIG. 9 is of the turboprop type, and that is to say the shaft fitted on the rotor assembly 110 is in mechanical engagement with a propeller 160 mounted on the front portion of the engine itself. The air intake pipe 140, in this specific case, arrives at a compression chamber which is fed by a turbine compressor the rotating shaft of which is made to rotate by a turbo assembly powered with the exhaust gases of the engine itself, which exit from an exhaust pipe 180; in detail, the gases exit via said exhaust pipe 180 either directly by way of the turbo assembly or by way of a valve of the wastegate or flow diverter type 185. In its turn, the turbine compressor assembly supplies an intake pipe for sending air into the combustion chambers, preferably but not exclusively fed through a shutter valve 150.

On each one of said first and second portions there are magnets positioned in such a way as to magnetize the air, polarizing it according to a first orientation. The shape and characteristics of the magnets are those described in the preferred embodiment described previously.

More precisely, the magnets that make it possible to achieve the magnetization of the entering air can be mounted, alternately or in combination, both upstream and downstream of the compressor assembly.

As illustrated in FIG. 10, which shows a front cross-section of a turbine engine of the jet type, such magnets 200 are installed so as to be radially arranged all around a central element of the rotor 110, which provides a rotating supporting shaft for the inflow fan of the jet engine shown in the figure. The same figure also shows that the magnets 200 are also arranged radially at the stator portion or housing of the engine itself. Although they are shown positioned outside the engine, such depiction should be understood not to be limiting given that it is furthermore possible to have an installation of magnets 200 inside the cowling of the engine. In any case, the north-south orientation of the magnets preferably, but not exclusively, follows the rotation axis of the rotor f the engine.

The fuel pipes, as already mentioned previously, are also characterized in that they can magnetize the fuel in a second direction that is orthogonal with respect the previous direction. This advantageously makes it possible to maintain a perceptible reduction in consumption of the engine in the present invention, and at the same time improve its efficiency of operation—in particular when it is operating under conditions of development of maximum engine torque—thus advantageously contributing to the reduction of pollutant emissions.

In particular, experiments carried out by the applicant have shown that the magnet positioned on board the fuel pipes must be arranged at a preset distance from the combustion chamber in order to optimize the reduction of consumption, which has been found experimentally to reach levels of up to 60%.

Although in the accompanying figures a turboprop engine has been described, it can equivalently be substituted by a jet engine.

The advantages of the turbine engine in the present invention are clear in light of the foregoing description. It enables a considerable reduction in consumption, in particular when it is operating at a fixed running speed; this is particularly advantageous in that during flight, differently from what occurs for vehicles, the engine runs substantially at a constant running speed with a constant torque load. It is therefore advantageously possible to carefully design the exact position of the magnets so as to succeed in maximally optimizing the yield of the engine much more thoroughly with respect to what occurs with traditional combustion engines of the Otto cycle type or Diesel fuel engines used in the automotive sector. The term magnet, in the present patent application for an industrial invention, means any permanent magnet that can be sourced on the market or any electromagnet with fixed or variable actuation, i.e. programmed with variable frequencies, optionally associated with a magnet and/or with a conventional device for emitting infrared rays, which also has a fixed or variable actuation.

The term fuel pipe, in the present patent application for an industrial invention, means the possibility of making the fuel itself flow through multiple passages of the same fuel pipe, in order to be able to amplify the effects on it. Said passes are achieved by way of any fixed or mobile and/or electronic redirecting device.

Finally, it is clear that what is described herein can be subjected to additions, modifications or variations which are obvious to a person skilled in the art but without for this reason leaving the scope of protection provided by the appended claims.

1. An combustion engine, comprising a first, fixed stator portion (100) and a second, mobile rotor portion (110), and wherein at least said first, fixed stator portion (110) identifies an air intake pipe (140) and wherein said second, mobile rotor portion (110) is positioned inside the first, fixed stator portion (100); said first and said second portion (100, 110) comprise magnetic means (200) which are configured to magnetize the air admitted in said intake pipe (140) with a first polarization; said combustion engine further comprising at least one fuel intake pipe, which in turn is physically associated with magnetic means which are configured to magnetize said fuel with a second polarization which is different from said first polarization.

2. The combustion engine according to claim 1, wherein said first, fixed stator portion (100) comprises at least one portion which is made of metal.

3. The combustion engine according to claim 1, wherein said magnetic means (200) are radially arranged around said first, fixed stator portion (100) and/or said second, mobile rotor portion (110).

4. The combustion engine according to claim 2, wherein said second, mobile rotor portion (120) comprises at least one portion which is made of metal.

5. The combustion engine according to claim 2, wherein said metal is a ferromagnetic or paramagnetic or diamagnetic material.

6. The combustion engine according to claim 1, further comprising a tank (2) having at least one immersion container (1), which is provided with a plurality of holes (40) and is placed proximate to the fuel pipe (8) and contains at least one cylindrical container (3), which is provided with a plurality of holes (41) and is adapted to contain in turn a plurality of magnetic elements or means (5) which are mutually separated by a corresponding number of non-magnetic spacers (6).

7. The combustion engine according to claim 1, wherein said magnetic elements or means comprise magnets that are made with ferromagnetic and/or paramagnetic elements, rare earth elements and, in particular, neodymium and samarium-cobalt rare earth elements.

8. The combustion engine according to claim 6, wherein said non-magnetic spacers (6) are ceramic spacers.

9. The combustion engine according to claim 1, further comprising an air compressor stage and wherein said magnetic means (200) are installed upstream of said air compressor stage.

10. The combustion engine according to claim 9, wherein said magnetic means (200) are furthermore also installed downstream of said air compressor stage.

11. A method of feeding a turbine engine, further comprising:
a first step of association of magnetic means (200) provided with a same first polarity with a first, fixed external portion (100) or stator portion of said turbine engine and with a second, mobile rotating internal portion (110) or rotor portion of said turbine engine;
a step of feeding said turbine engine with a fuel flow passing inside a feed pipe that comprises magnetic means which are provided with a second polarity, different from said first polarity;
a step of feeding air into a combustion chamber (130) which is internal to said turbine engine and is provided at least partially inside said first external portion, and of a subsequent mixing of said air with said fuel;
and wherein said step of feeding said air into said combustion chamber is further comprising a magnetization of the air molecules according to a first polarity which is different from said second polarity assumed by the molecules of said fuel.

12. The method according to claim 11, further comprising an installation of magnetic means inside a body of a fuel filter of said engine, said magnetic means being configured to allow the further magnetization of said fuel.

13. The method according to claim 10, wherein said magnetic means are positioned at a preset distance with respect to said combustion chamber, and wherein said distance is calculated according to at least one maximum torque speed of said turbine engine.

14. The method according to claim 10, wherein said fuel passes through a fuel filter (31) which is in turn magnetized thanks to at least one pair of magnetic means (16) which are directly placed on said fuel filter (31) and are adapted to create a polarization with a sign which is the same as the one provided by the magnetic means which are positioned at at least one fuel intake pipe of said combustion engine.

15. The combustion engine according to claim 3, wherein said second, mobile rotor portion (120) comprises at least one portion which is made of metal.

16. The combustion engine according to claim 3, wherein said metal is a ferromagnetic or paramagnetic or diamagnetic material.

17. The combustion engine according to claim 4, wherein said metal is a ferromagnetic or paramagnetic or diamagnetic material.

18. The combustion engine according to claim 2, further comprising a tank (2) having at least one immersion container (1), which is provided with a plurality of holes (40) and is placed proximate to the fuel pipe (8) and contains at least one cylindrical container (3), which is provided with a plurality of holes (41) and is adapted to contain in turn a plurality of magnetic elements or means (5) which are mutually separated by a corresponding number of non-magnetic spacers (6).

19. The combustion engine according to claim 3, further comprising a tank (2) having at least one immersion container (1), which is provided with a plurality of holes (40) and is placed proximate to the fuel pipe (8) and contains at least one cylindrical container (3), which is provided with a plurality of holes (41) and is adapted to contain in turn a plurality of magnetic elements or means (5) which are mutually separated by a corresponding number of non-magnetic spacers (6).

20. The combustion engine according to claim 4, further comprising a tank (2) having at least one immersion container (1), which is provided with a plurality of holes (40) and is placed proximate to the fuel pipe (8) and contains at least one cylindrical container (3), which is provided with a plurality of holes (41) and is adapted to contain in turn a plurality of magnetic elements or means (5) which are mutually separated by a corresponding number of non-magnetic spacers (6).
